(19) United States
(12) Patent Application Publication
(10) Pub. No.: US 2008/0165653 A1
(43) Pub. Date: Jul. 10, 2008

(54) METHOD AND APPARATUS FOR RECORDING AND/OR REPRODUCING DATA ON AND/OR FROM HOLOGRAPHIC STORAGE MEDIUM

(75) Inventors: Sung-hee Hwang, Suwon-si (KR); Jin-han Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/753,845

(22) Filed: May 25, 2007

(30) Foreign Application Priority Data
Jan. 4, 2007 (KR) 2007-1165

(51) Int. Cl. G11B 7/00

(52) U.S. Cl. 369/103

(57) ABSTRACT

A method and an apparatus for recording and/or reproducing data on/from a holographic storage medium, the method includes: calculating an on to off pixel ratio of the page; inverting data of the page according to the on to off pixel ratio to generate a page to be recorded; and recording the generated page.

### CROSS-REFERENCE TO RELATED APPLICATION

This application claims the benefit of Korean Patent Application No. 2007-1165, filed on Jan. 4, 2007, in the Korean Intellectual Property Office, the disclosure of which is incorporated herein in its entirety by reference.

### BACKGROUND OF THE INVENTION

1. Field of the Invention

An aspect of the present invention relates to a method and an apparatus for recording and/or reproducing data on/from a holographic storage medium.

2. Description of the Related Art

For optical storage media, data is stored within a recording medium in optical holography and not on a surface thereof. Signal light interferes with reference light inside the recording medium to generate an interference grating called a data page. A plurality of interference gratings vary optical characteristics of the reference light to overlap with one another. This process is called multiplexing. During reading of data, the single reference light is incident on the recording medium under the conditions that data is recorded to generate diffraction light indicating a stored data page. The diffraction light is detected by a detection array which extracts stored data bits from a measured intensity pattern. A data page includes a large number of data bits or pixels. A plurality of data pages may overlap within a unit volume to increase a storage capacity. A hologram is recorded using signal light including the data, and the reference light.

FIGS. 1A and 1B are reference views illustrating recording and/or reproduction in holography. As shown in FIG. 1A, during recording, reference light R and signal light S interfere with each other to generate an interference pattern, and then the interference pattern is transmitted to a medium.

As shown in FIG. 1B, during reproduction, if original reference light R is irradiated onto a hologram recorded on the medium, the hologram is diffracted to generate output signal light S.

Recording on a hologram storage medium is achieved through interference between the signal light and the reference light. The signal light is formed in a page format including a plurality of pixels through a spatial optical modulator. The signal light interferes with reference light on the hologram storage medium through an optical system. An interference pattern formed by the interference between the signal light and the reference light is recorded on the hologram storage medium. Reference light is incident on the recorded interference pattern to reproduce the original signal light due to a diffraction phenomenon.

An intensity and a phase of the signal light may be recorded using a method of varying an angle of the reference light during recording of the hologram. Hundreds to thousands of holograms may be recorded in the same position of a unit page including binary data. The page may be turned on or off to indicate information of a corresponding pixel.

Here, field characteristics of a lens vary with its position to record and/or reproduce data in the hologram. In other words, a characteristic of a center of the lens is good, but a modulation transfer function (MTF) characteristic is deteriorated toward an edge of the lens. Here, the MTF is a variation of a spatial frequency characteristic with respect to a signal, (i.e., an index of characteristics and functions of the lens). If the MTF is deteriorated, signal quality of page data deteriorates towards the edges of a page.

When the signal light is transmitted to the hologram storage medium in the page format through the spatial optical modulator, an intensity of the signal light varies in the center and at edges of a page due to the characteristics of the lens. In other words, the intensity of the signal light is reduced from the center of the page towards the edges of the page and thus has a Gaussian distribution. Thus, light intensity of an on pixel at the edges of the page is relatively smaller than the light intensity of an on pixel in the center of the page during recording of the page. As a result, on and/or off pixel rates between the center and the edges of the page are different.

Also, light is intercepted by an off pixel, but light passes through an on pixel. Thus, only the on pixel has energy. As a result, noise distributions of the on and/or off pixels are asymmetric due to a difference between energies of the on and off pixels, compared to an existing optical storage medium. Here, since noise is proportional to energy, a page includes a great deal of noise when it has many on pixels. In other words, if light passes through a “1” bit pixel, but light is intercepted by a “0” bit pixel to perform recording, a page includes a lot of noise when it has a large number of “1” bit pixels.

Accordingly, in the prior art, a number of on pixels is smaller than a number of off pixels in a predetermined unit using a modulation method. Thus, additional data is required. As a result, an amount of substantial user data is reduced.

### SUMMARY OF THE INVENTION

As aspect of the present invention provides a method and an apparatus for recording and/or reproducing data on/from a holographic storage medium in which a number of on pixels of page data is reduced using a small amount of additional data information so as to improve signal quality and reliability.

According to an aspect of the present invention, there is provided a method of recording data on a holographic storage medium on which holograms including data are recorded in units of pages by using interference between signal and reference beams, including: calculating an on to off pixel ratio of the page; inverting data of the page depending on the on to off pixel ratio to generate a page to be recorded; and recording the generated page.

According to another aspect of the present invention, the method may further include dividing the page into a plurality of sub-pages, and the generation of the page to be recorded may include: calculating an on to off pixel ratio of at least one of the sub-pages; and inverting data of the sub-pages if the on to off pixel ratio exceeds a reference value to generate the page.

According to another aspect of the present invention, before dividing the page into the plurality of sub-pages, the method may further include performing ECC (error correction coding) on the data of the page.

According to another aspect of the present invention, the generation of the page to be recorded may further include: generating and encoding state information of the sub-pages including the inverted data; and combining the state information and the data of the sub-pages to generate the page to be recorded.

According to another aspect of the present invention, the generation of the page to be recorded may include: generating state information of the sub-pages including the inverted data; combining the state information and the data of the sub-pages to generate the page to be recorded; and performing ECC on the generated page.

According to another aspect of the present invention, on and off pixels of a sub-page having the on to off pixel ratio of 50% or more may be inverted into off and on pixels, respectively.

According to another aspect of the present invention, the state information may include: header information including at least one of a total number of sub-pages and a number of sub-pages including the inverted data; and a sub-page entry including at least one of whether the sub-pages have been inverted and an amount of on pixels contained in the sub-pages.

According to another aspect of the present invention, there is provided a method of reproducing data from a holographic storage medium on which holograms including data are recorded in units of pages by using interference between signal and reference beams, including: reading a page from the holographic storage medium using the reference beam; decomposing the read page into page data and state information indicating whether the page data has been inverted; and re-inverting data of the page based on the state information.

According to another aspect of the present invention, the page may be divided into a plurality of sub-pages, and on and off pixels of at least one of the sub-pages may be inverted into off and on pixels, respectively, depending on an on to off pixel ratio.

According to another aspect of the present invention, before re-inverting the data of the page, the method may further include decoding the state information, and after re-inverting the data of the page, the method may further include performing error correction decoding on the data of the page.

According to another aspect of the present invention, before re-inverting the data of the page, the method may further include decoding the data of the page and the state information.

According to another aspect of the present invention, the state information may include: header information including at least one of a total number of sub-pages and a number of sub-pages including the inverted data; and a sub-page entry including at least one of whether the sub-pages have been inverted and a number of on pixels.

According to another aspect of the present invention, there is provided an apparatus for recording data on a holographic storage medium on which holograms including data are recorded in units of pages by using interference between signal and reference beams, including: an optical processor recording data on the holographic storage medium using the signal and reference beams; and a controller controlling the optical processor to invert data of a page so as to record a generated page according to an on to off pixel ratio of the page.

According to another aspect of the present invention, the controller may control the optical processor to divide the page into a plurality of sub-pages and invert data of the sub-pages if an on to off pixel ratio of at least one of the sub-pages exceeds a reference value so as to record the generated page.

According to another aspect of the present invention, the controller may include: an ECC encoder encoding data of the page to correct an error; a page data inverter dividing the page into the plurality of sub-pages and inverting data of the sub-pages according to an on to off pixel ratio of each of the sub-pages; a state information encoder encoding state information indicating whether the data of the sub-pages has been inverted; and a page generator combining the state information and the data of the page to record the generated page.

According to another aspect of the present invention, the controller may include: a page data inverter dividing the page into the plurality of sub-pages and, for each of the sub-pages, inverting data of the sub-pages if an on to off pixel ratio of a sub-page exceeds a reference value; an ECC encoder encoding state information indicating whether data of the plurality of sub-pages has been inverted and the data of the sub-pages; and a page generator combining the state information and the data of the sub-pages to record the generated page.

According to another aspect of the present invention, the page data inverter may include: a page divider dividing the page into a plurality of sub-pages; a bit counter calculating an on to off pixel ratio of each of the sub-pages; an inverting controller inverting and recording data of the sub-pages if the on to off pixel rate exceeds a reference value; and a state information generator generating the state information.

According to another aspect of the present invention, there is provided an apparatus for reproducing data from a holographic storage medium on which holograms including data are recorded in units of pages by using interference between signal and reference beams, including: an optical processor reading a page from the holographic storage medium using the reference beam; and a controller decomposing the page into page data and state information indicating whether the page data has been inverted and re-inverting the data of the page based on the state information.

According to another aspect of the present invention, the controller may include: a page decomposer decomposing the read page into page data and state information indicating whether the plurality of sub-pages have been inverted; and an inverting controller re-inverting on and off pixels of data of the sub-pages including the inverted data using the state information into off and on pixels, respectively.

According to another aspect of the present invention, there is provided a holographic storage medium on which holograms comprising data are recorded in units of pages due to interference between signal and reference beams, wherein data of the page is inverted if an on to off pixel ratio of the page exceeds a reference value to generate and record a page.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are reference views illustrating recording and/or reproduction in an optical holography;

FIG. 2 is a schematic block diagram of a hologram recording and/or reproducing apparatus according to an embodiment of the present invention;

FIG. 3 is a block diagram illustrating a method of a controller for recording a data page according to an embodiment of the present invention;

FIG. 4 is a view illustrating page data generated by a page generator according to an embodiment of the present invention;

FIG. 5 is a view illustrating state information of page data according to an embodiment of the present invention;

FIG. 6 is a block diagram illustrating a method of the controller 400 of FIG. 3 for recording a data page according to another embodiment of the present invention;

FIG. 7 is a block diagram illustrating a method of the controller 400 of FIG. 3 for reproducing a data page according to an embodiment of the present invention; and

FIG. 8 is a block diagram illustrating a method of the controller 400 of FIG. 3 for reproducing a data page according to another embodiment of the present invention.

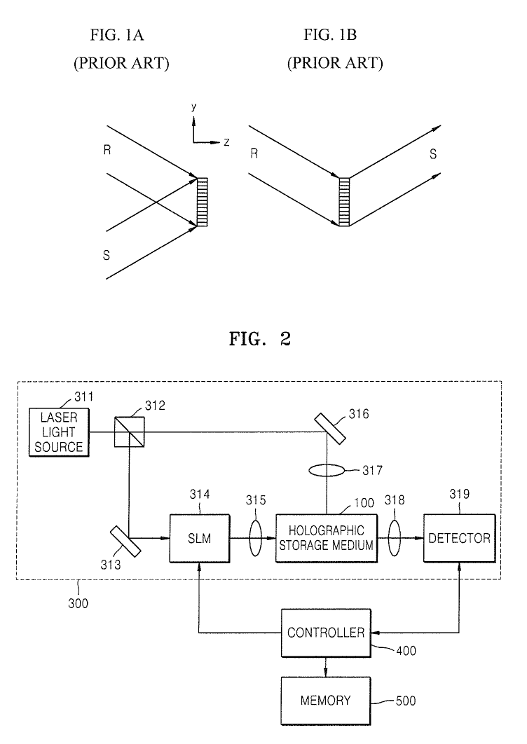

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 2 is a schematic block diagram of a hologram recording and/or reproducing apparatus according to an embodiment of the present invention. Referring to FIG. 2, the hologram recording and/or reproducing apparatus includes an optical processor 300, a controller 400, and a memory 500. A holographic storage medium 100 is inserted into the optical processor 300. The controller 400 controls the optical processor 300 to record data on the holographic storage medium 100 or reproduce data from the holographic storage medium 100. The memory 500 temporarily stores data (such as the state information described below in relation to FIG. 5) read from the holographic storage medium 100 or to be recorded on the holographic storage medium 100. The optical processor 300 includes a laser light source 311, a beam splitter 312, a first reflector 313, a spatial light modulator (SLM) 314, a first lens 315, a second reflector 316, a second lens 317, a third lens 318, and a detector 319. While shown as a recording and reproducing apparatus, it is understood that the apparatus need not perform both recording and reproducing in all aspects. Further, the medium 100 can be removable or non-removable in other aspects, and the memory 500 can be a RAM, flash memory, or other memory suitable for temporary and/or permanent data storage.

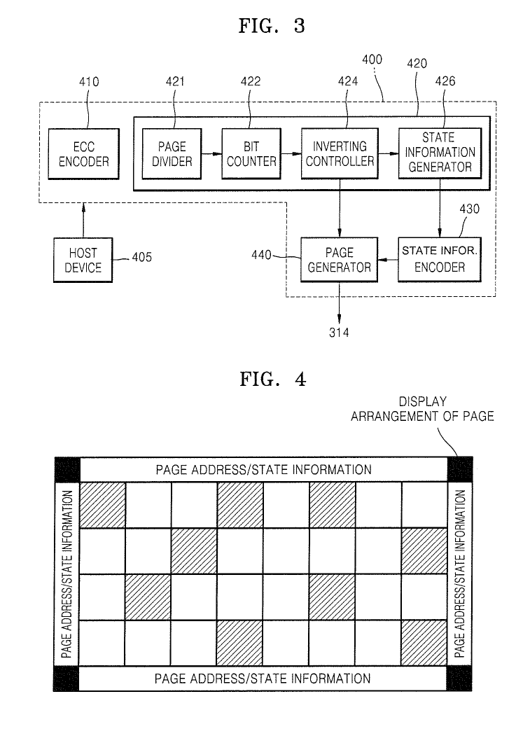

The controller 400 controls the optical processor 300, generates page data including recorded data, transmits the page data to the optical processor 300, and processes a signal reproduced from the optical processor 300. In particular, the controller 400 according to the present embodiment controls the optical processor 300 to divide each page recorded on the holographic storage medium 100 into a plurality of areas according to the quality of the reproduced signal, calculate the ratio of on pixels to off pixels in the plurality of areas, and record interleaved data in the areas having on pixels in the amount of 50% or more of all pixels therein. Methods of the controller 400 for generating and recording or reproducing a data page will be described in detail later with reference to FIGS. 3 through 8.

Processes of recording data on the holographic storage medium 100 and reproducing the recorded data will now be described. When data is recorded on the holographic storage medium 100, a coherent laser beam is output from the laser light source 311 and is incident on the beam splitter 312. Thus, the coherent laser beam is split into reference and signal beams by the beam splitter 312. The signal beam indicating recorded data is reflected from the first reflector 313 and is incident on the SLM 314 and is then spatially modulated (amplitude modulated). The modulated signal beam is focused on the holographic storage medium 100 by the first lens 315. The reference beam is reflected from the second reflector 316 and thus irradiated on the holographic storage medium 100 through the second lens 317. Thus, the signal and reference beams overlap with each other to form an interference pattern. As a result, the interference pattern is recorded as a micro-dense pattern on the holographic storage medium 100.

To reproduce data from the holographic storage medium 100, an illumination beam identical to the reference beam used to record a data page, to be reproduced, is incident on the holographic storage medium 100. Thus, data is reproduced from the holographic storage medium 100 through a diffraction beam corresponding to the interference pattern. The diffraction beam is focused on the detector 319, which can be a charge-coupled device (CCD) or complementary metal-oxide semiconductor (CMOS), by the third lens 318. A reproduction signal output from the detector is transmitted to the controller 400.

A method performed by the controller 400 for generating and recording a data page will now be described with reference to FIGS. 3 through 6. FIG. 3 is a block diagram illustrating a method performed by the controller 400 for recording a data page according to an embodiment of the present invention. Referring to FIG. 3, the controller 400 according to the present embodiment includes an error correction code (ECC) encoder 410, a page data inverter 420, a state information encoder 430, and a page generator 440. The page data inverter 420 includes a page divider 421, a bit counter 422, an inverting controller 424, and a state information generator 426.

If a write command of a host device 405 is transmitted to the controller 400, the ECC encoder 410 of the controller 400 adds parity to original page data to encode the original page data so that an error which may occur during reproduction can be corrected. Here, the host device 405 may be a personal computer (PC), an A/V system, a display device, etc. Although not shown, the host device 405 communicates wired or wirelessly with the controller 400 using an interface or the like.

The encoded page data is input to the page divider 421 of the page data inverter 420. The page divider 421 divides the encoded page data into a plurality of sub-pages. The bit counter 422 counts numbers of “0” and “1” of data of each of the sub-pages and/or calculates the ratio of the numbers of “0” and “1” in each of the sub-pages.

In other words, if on pixels of binary page data are represented as “1” and off pixels of the binary page data are represented as “0,” a ratio of on to off pixels is output. The inverting controller 424 compares the calculated on to off pixel ratio with a reference value to determine whether a data value is to be inverted, and transmits generated page data as shown in FIG. 4 to the page generator 440 according to the determination result. The page generator 440 forms final page data and outputs the final page data to the SLM 314.

FIG. 4 is a view illustrating page data generated by the page generator 440 according to an embodiment of the present invention. As shown in FIG. 4, a page including an arrangement of encoded bits (1232, 720) input to the page data inverter 420 is divided into 32 sub-pages. Data of the sub-pages having on to off pixel ratio greater than a reference value is inverted by the inverting controller 424 as marked with slanted lines.

By way of example, if the reference value is 50%, the inverting controller 424 inverts “1” to “0” and “0” to “1” in data areas of sub-pages having an on to off pixel ratio greater than 50%. Thus, the on to off pixel ratio of all of the sub-pages will not exceed 50% so that numbers of on pixels are smaller than numbers of off pixels and standard deviations of the on to off pixel ratios are reduced. However, other reference values can be used.

The state information generator 426 generates state information as shown in FIG. 5 and outputs the state information to the state information encoder 430 according to whether data of the sub-pages has been inverted. The state information encoder 430 encodes the state information and outputs the encoded state information to the page generator 440. While not required in all aspects, the state information encoder 430 may repeatedly encode the state information to improve reliability of encoding.

FIG. 5 is a view illustrating state information 442 of page data according to an embodiment of the present invention. Referring to FIG. 5, the state information 442 of the page data includes header information 444 and a sub-page entry 446. The header information 444 includes a total number of sub-pages and a number of inverted sub-pages. The sub-page entry 446 indicates whether the sub-pages have been inverted and the amount of “1” pixels after inversion.

By way of the shown example, when page data is divided into 32 sub-pages as shown in FIG. 4, whether any sub-pages have been inverted and the amounts of “1” pixels after inversion are recorded. Here, in any of the first through thirty second sub pages, if the amount of “1” pixels is more than or equal to 50%, the sub-page is inverted. Thus, the amount of “1” pixels of each of the sub-pages is written. The amount of “1” pixels after inversion may be written as described above to display information with a minimum number of bits.

The page generator 440 combines the inverted page data, the encoded state information 442, page addresses, and page align marks to form final page data as shown in FIG. 4 and outputs the final page data to the SLM 314. Here, state information 442 of sub-pages as shown in FIG. 5 is added to both sides of the inverted page data, and four page align marks are added to corners of the page data. A signal beam is transmitted in the page format to the hologram storage medium 100 in response to the page data input to the SLM 314. It is understood that the state information can be otherwise disposed on the final page in aspects of the invention.

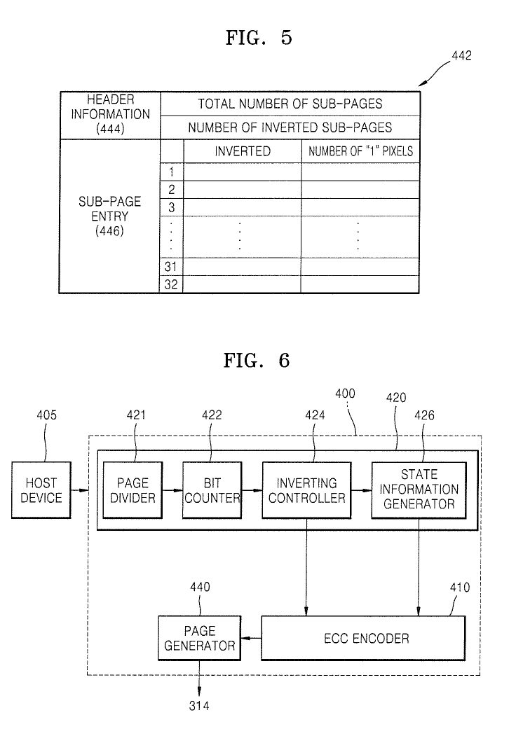

FIG. 6 is a block diagram illustrating a method performed by the controller 400 for recording a data page according to another embodiment of the present invention. Referring to FIG. 6, the method of the present embodiment is different from the method of FIG. 3 in that page data and state information pass through the data inverter 420 and then are simultaneously encoded by the ECC encoder 410.

In other words, the write command of the host device 405 is transmitted to the controller 400, the page divider 421 of the controller 400 divides an original page into a plurality of sub-pages. The bit counter 422 counts numbers of “1” and “0” of each of the sub-pages and outputs on to off pixel ratio. The inverting controller 424 compares the on to off pixel ratio with a reference value to determine whether data values are to be inverted and transmits the page data, which may or may not have been inverted, to the ECC encoder 410. The state information generator 426 generates state information according to whether the data of the sub-pages has been inverted and transmits the state information to the ECC encoder 410.

Here, different from the previous embodiment shown in FIG. 3, the ECC encoder 410 simultaneously encodes the page data and the state information 442 to correct an error. When the encoded page data and state information 442 are output, the page generator 440 combines the page data, the encoded state information 442, page addresses, and page align marks to form a page and transmits the page to the SLM 314.

According to the present embodiment of FIG. 6, the ECC encoder 410 is disposed after the page data inverter 420 to simultaneously encode the page data and the state information so as to correct the error. Thus, a number of encoders can be reduced compared to the previous embodiment of FIG. 3.

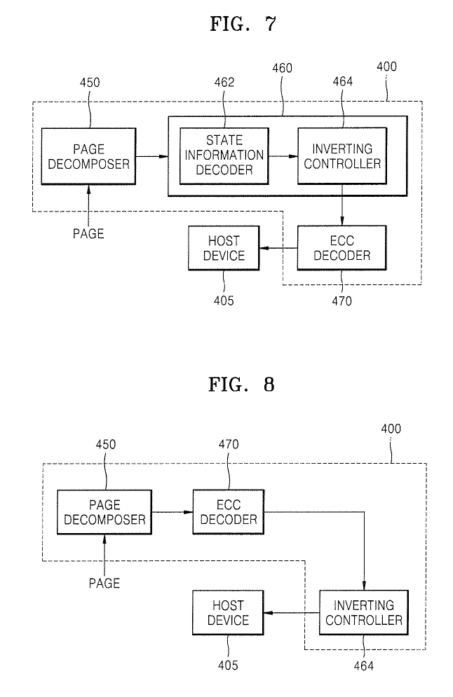

A method performed by the controller 400 for generating and reproducing a data page will now be described with reference to FIGS. 7 and 8. FIG. 7 is a block diagram illustrating a method performed by the controller 400 for reproducing a data page according to another embodiment of the present invention. Referring to FIG. 7, the controller 400 includes a page data decomposer 450, a page data inverter 460, and an ECC decoder 470. The page data inverter 460 includes a state information decoder 462 and an inverting controller 464.

If a page is input to the page data decomposer 450 of the controller 400, the page data decomposer 450 decomposes the page into page data and state information 442 as shown in FIGS. 4 and 5. Here, the page data decomposer 450 arranges the page data using page align marks and then transmits the page data and the state information 442 to the data inverter 460.

The state information decoder 462 of the page data inverter 460 decodes the state information 442 which is encoded by a repetition code, and transmits the decoding result to the inverting controller 464. The inverting controller 464 inverts inverted and recorded sub-page data using the decoding result received from the state information decoder 462 and transmits the page data to the ECC decoder 470. The ECC decoder 470 decodes the page data to correct an error of the page data and transmits the page data to a host device 405 so as to reproduce the page data.

FIG. 8 is a block diagram illustrating a method performed by the controller for reproducing a data page according to another embodiment of the present invention. Referring to FIG. 8, the method of the present embodiment is different from the method of FIG. 7 in that page data and state information are simultaneously decoded by the ECC decoder 470 and then pass through the inverting controller 464. In other words, if a page is input to the page data decomposer 450 of the controller 400, the page data decomposer 450 decomposes the page into page data and state information 442. Here, the page data decomposer 450 arranges the page data using page align marks and then transmits the page data and the state information to the ECC decoder 470.

The ECC decoder 470 decodes the page data and the state information 442 to correct an error of the page data and then outputs the error corrected page data and the state information to the inverting controller 464. The inverting controller 464 inverts inverted and recorded sub-page data using the state information and transmits the page data to the host device 405 so as to reproduce the page data. In other words, according to the present embodiment, data of sub-pages having a high on to off pixel ratio is inverted and recorded during recording and then re-inverted to reproduce original data during reproduction.

As described above, in a method and an apparatus for recording and/or reproducing data on and/or from a holographic storage medium according to the embodiments of the present invention, an on to off pixel ratio and a standard deviation of an on to off pixel ratio can be reduced. Thus, reproduction quality of a reproduced signal can be improved and signal quality of whole page data can be improved using a small amount of additional data information.

While not required in all aspects, embodiments of the present invention can be written as computer programs and can be implemented in one or more processes and/or general-use digital computers that execute the programs using computer readable recording media. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of recording data on a holographic storage medium on which holograms comprising the data are recorded as on-pixels and off-pixels in units of pages by using interference between signal and reference beams, the method comprising:
calculating an on-to-off pixel ratio of the page;
inverting data of the page depending on the on to off pixel ratio to generate a page to be recorded; and
recording the generated page.

2. The method of claim 1, further comprising dividing the page into a plurality of sub-pages,
wherein calculating and inverting for the page comprises:
calculating an on-to-off pixel ratio of at least one of the sub-pages; and
inverting data of the sub-pages when the on-to-off pixel ratio exceeds a reference value to generate the page.

3. The method of claim 2, wherein before dividing the page into the plurality of sub-pages, performing ECC (error correction coding) on the data of the page.

4. The method of claim 3, wherein the generation of the page further comprises:
generating and encoding state information of the sub-pages comprising the inverted data; and
combining the state information and the data of the sub-pages to generate the page.

5. The method of claim 2, wherein the generation of the page further comprises:
generating state information of the sub-pages comprising the inverted data, the state information indicating an extent of the inverted data in the sub-pages;
combining the state information and the non-inverted data of the sub-pages to generate the page; and
performing ECC on the generated page.

6. The method of claim 2, wherein the on and the off pixels of a sub-page having the on-to-off pixel ratio of 50% or more are inverted into off and on pixels, respectively.

7. The method of claim 4, wherein the state information comprises:
header information including at least one of a total number of sub-pages and a number of sub-pages including the inverted data; and
a sub-page entry including identifying each sub-page and at least one of whether the identified sub-page has been inverted and an amount of on pixels contained in the identified sub-page.

8. The method of claim 5, wherein the state information comprises:
header information including at least one of a total number of sub-Pages and a number of sub-pages including the inverted data; and
a sub-page entry including at least one of whether the sub-pages have been inverted and an amount of on pixels contained in the sub-pages.

9. A method of reproducing data from a holographic storage medium on which holograms comprising the data are recorded in units of pages by using interference between signal and reference beams, the method comprising:
reading a page from the holographic storage medium using the reference beam;
decomposing the read page into page data and state information indicating whether one or more pixels of the page data has been inverted; and
re-inverting the one or more inverted pixels of the page data based on the state information.

10. The method of claim 9, wherein the page is divided into a plurality of sub-pages, wherein on and off pixels of at least one of the sub-pages are inverted into off and on pixels, respectively, depending on an on to off pixel ratio.

11. The method of claim 10, wherein before the re-inverting, decoding the state information, and after re-inverting the page data performing error correction decoding on the data of the page.

12. The method of claim 10, wherein before the re-inverting, decoding the page data and the state information.

13. The method of claim 10, wherein the state information comprises:
header information including at least one of a total number of sub-pages and a number of sub-pages including the inverted data; and
a sub-page entry including identifying each sub-page and at least one of whether the identified sub-page has been inverted and a number of on pixels contained in the identified sub-page.

14. The method of claim 10, wherein the one and off pixels of the at least one of the sub-pages are re-inverted into off and on pixels, respectively, based on the state information.

15. An apparatus for recording data on a holographic storage medium on which holograms comprising the data are recorded as on pixels and off pixels in units of pages by using interference between signal and reference beams, the method comprising:
an optical processor recording the data on the holographic storage medium using the signal and reference beams; and
a controller controlling the optical processor to invert data of a page according to an on to off pixel ratio of the page.

16. The apparatus of claim 15, wherein the controller controls the optical processor to divide the page into a plurality of sub-pages and invert data of the sub-pages when an on to off pixel ratio of at least one of the sub-pages exceeds a reference value so as to record the generated page.

17. The apparatus of claim 16, wherein the controller comprises:
an ECC encoder encoding the page data to correct an error;
a page data inverter dividing the page into the plurality of sub-pages and inverting the data of the sub-pages according to the on to off pixel ratio of each of the sub-pages;
a state information encoder encoding state information indicating whether the data of the sub-pages has been inverted; and
a page generator combining the state information and the page data to record the generated page.

18. The apparatus of claim 16, wherein the controller comprises:
a page data inverter dividing the page into the plurality of sub-pages and, for each of the sub-pages, inverting the data of the sub-pages if an on to off pixel ratio of the sub-pages exceeds the reference value;
an ECC encoder encoding state information, indicating whether the data of the plurality of sub-pages has been inverted, and the data of the sub-pages; and
a page generator combining the state information and the data of the sub-pages to record the generated page.

19. The apparatus of claim 17, wherein the page data inverter comprises:
a page divider dividing the page into the plurality of sub-pages;
a bit counter calculating the on to off pixel ratio of each of the sub-pages;
an inverting controller inverting and recording the data of the sub-pages if the on to off pixel rate exceeds the reference value; and
a state information generator generating the state information.

20. The apparatus of claim 18, wherein the page data inverter comprises:
a page divider dividing the page into the plurality of sub-pages;
a bit counter calculating the on to off pixel ratio of each of the sub-pages;
an inverting controller inverting and recording the data of the sub-pages if the on to off pixel rate exceeds the reference value; and
a state information generator generating the state information.

21. The apparatus of claim 19, wherein the inverting controller inverts on and off pixels of the sub-pages having the on to off pixel ratio of 50% or more into off and on pixels, respectively.

22. The apparatus of claim 19, wherein the state information comprises:
header information including at least one of a total number of sub-pages and a number of sub-pages including the inverted data; and
a sub-page entry including at least one of whether the sub-pages have been inverted and a number of on pixels.

23. The apparatus of claim 20, wherein the inverting controller inverts on and off pixels of the sub-pages having the on to off pixel ratio of 50% or more into off and on pixels, respectively.

24. The apparatus of claim 20, wherein the state information comprises:
header information including at least one of a total number of sub-pages and a number of sub-pages including the inverted data; and
a sub-page entry including at least one of whether the sub-pages have been inverted and a number of on pixels.

25. An apparatus for reproducing data from a holographic storage medium on which holograms comprising the data are recorded in units of pages by using interference between signal and reference beams, the apparatus comprising:
an optical processor reading a page from the holographic storage medium using the reference beam; and
a controller decomposing the page into page data and state information indicating whether the page data has been inverted and re-inverting the page data based on the state information.

26. The apparatus of claim 25, wherein the page is divided into a plurality of sub-pages, wherein, for at least one of the plurality of sub-pages, on and off pixels are inverted into off and on pixels, respectively, based on an on to off pixel ratio.

27. The apparatus of claim 26, wherein the controller comprises:
a page decomposer decomposing the read page into the page data and the state information indicating whether the plurality of sub-pages have been inverted; and
an inverting controller re-inverting on and off pixels of the sub-pages comprising the inverted data using the state information into off and on pixels, respectively.

28. The apparatus of claim 27, wherein the controller further comprises:
a state information decoder decoding the state information before the plurality of sub-pages are re-inverted; and
an ECC decoder performing error correction decoding on the page data after the plurality of sub-pages are re-inverted.

29. The apparatus of claim 27, further comprising an ECC decoder decoding the page data and the state information before the plurality of sub-pages are re-inverted.

30. The apparatus of claim 26, wherein the state information comprises:
header information including at least one of a total number of sub-pages and a number of sub-pages including the inverted data; and
a sub-page entry including at least one of an indicator indicating whether the sub-pages have been inverted and a number of on pixels.

31. The apparatus of claim 25, wherein the apparatus further records on the holographic storage medium by using the optical processor to record the data on the holographic storage medium using the signal and reference beams and the controller to control the optical processor to invert page data so as to record a generated page according to an on to off pixel ratio of the page.

32. A holographic storage medium comprising:
holograms comprising data recorded in units of pages due to interference between signal and reference beams, and
inverting data used by an apparatus reproducing the holographic storage medium to execute a method of reproducing the data from the holographic storage medium by detecting from the inverting data which portions of the data of at least one of the pages has been inverted when an on-to-off pixel ratio of the page exceeds a reference value and which portions are not inverted when the page was generated and recorded.

33. The holographic storage medium of claim 32, wherein the at least one of the pages is divided into a plurality of sub-pages, data of the sub-pages are inverted according to the on-to-off pixel ratio of at least one of the plurality of sub-pages to generate the page.

34. The holographic storage medium of claim 33, wherein on and off pixels of a sub-page having the on to off pixel ratio of 50% or more are inverted into off and on pixels.

35. The holographic storage medium of claim 33, wherein state information of the sub-pages is further recorded and is used by the reproducing apparatus to identify inverted sub-pages to reconstruct the original page.

36. The holographic storage medium of claim 35, wherein the state information comprises:
header information including at least one of a total number of sub-pages and a number of sub-pages including the inverted data; and
a sub-page entry including at least one of whether the sub-pages have been inverted and a number of on pixels.

37. A method of recording and/or reproducing data on and reproducing the data from a holographic storage medium on which holograms comprising the data are recorded as on-pixels and off-pixels in pages by using interference between signal and reference beams, the method comprising:
calculating an on-to-off pixel ratio of one of the pages;
inverting the data of the page depending on the on-to-off pixel ratio to generate a page to be recorded;
recording the generated page;
reading the recorded generated page from the holographic storage medium using the reference beam;
decomposing the read page into page data and state information indicating whether one or more pixels of the page data have been inverted; and
re-inverting the one or more inverted pixels of the page data based on the state information.
